(19) United States
(12) Patent Application Publication
(10) Pub. No.: US 2008/0134453 A1
(43) Pub. Date: Jun. 12, 2008

(54) Fork lift broom

(76) Inventor: Rick Walters, Ft. Worth, TX (US)

Correspondence Address: Rick Walters, 7908 Stanley Street, Forth Worth, TX, 76180, US

(21) Appl. No.: 11/634,650

(22) Filed: Dec. 7, 2006

(51) Int. Cl. B60S 11/00

(52) U.S. Cl. 15/246

(57) ABSTRACT

A sweeper mounted to a forklift, the sweeper, in an exemplary embodiment comprising a center broom, concave in shape, the center broom attached to two fork receivers receiving and held by forklift forks, whereby the center broom is held by the two forks. The apparatus further comprises a left broom and a right broom, each of which is independently mounted, by action of the corresponding fork receiver, to a corresponding fork of the forklift. In the exemplary embodiment, each of the right and left fork receivers may have adjusting mechanisms for adjusting the angle of the corresponding right and left brooms.

### FIELD

The present invention relates generally to industrial brooms and sweeping devices; more particularly the present invention is disclosed as a broom that is attached to the forks of a forklift.

### BACKGROUND

Warehouse cleanliness is essential for safety, health and efficiency. Clean aisles and pathways reduce the frequency of accidents, and are more pleasing to customers and workers.

Almost every warehouse has a forklift. What is needed is an industrial quality broom that may be attached to a forklift, and used to sweep and clean.

### SUMMARY

Herein is disclosed a sweeping apparatus that is removably attached to the forks of a forklift. The sweeping apparatus, in the exemplary embodiment, is comprised of at least one broom attached to at least one fork-receiver, the fork receiver receiving a fork, whereby the broom is held by the fork for sweeping when the forklift is driven.

In an exemplary embodiment, the apparatus comprises a center broom, concave in shape, the center broom attached to two fork receivers, whereby the center broom is held by two forks of a typical fork lift. The apparatus further comprises a left broom and a right broom, each of which is independently mounted, by action of the corresponding fork receiver, to a corresponding fork of the forklift. In the exemplary embodiment, each of the right and left fork receivers may have adjusting mechanisms for adjusting the angle of the corresponding right and left brooms.

The apparatus as exemplified in the embodiment disclosed below will be seen to have several benefits and advantages. One such advantage is the apparatus may be used on any standard forklift, obviating the need for purchase of a motor driven sweeper.

Another advantage and benefit is the apparatus may be adjusted to accommodate various aisle widths.

And yet another advantage and benefit is the apparatus is simple to configure, install and remove.

The benefits and advantages of the invention will appear from the disclosure to follow. In the disclosure reference is made to the accompanying drawings, which form a part hereof and in which is shown by way of illustration a specific embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### BRIEF DESCRIPTION OF DRAWINGS

FIG. 1 shows the exemplary embodiment of the sweeping apparatus installed on a forklift.

FIG. 2 shows the basic components of the exemplary embodiment.

FIG. 3 shows the adjusting mechanism for adjusting the angle of either a left broom or a right broom.

### THE DRAWINGS—LABELING

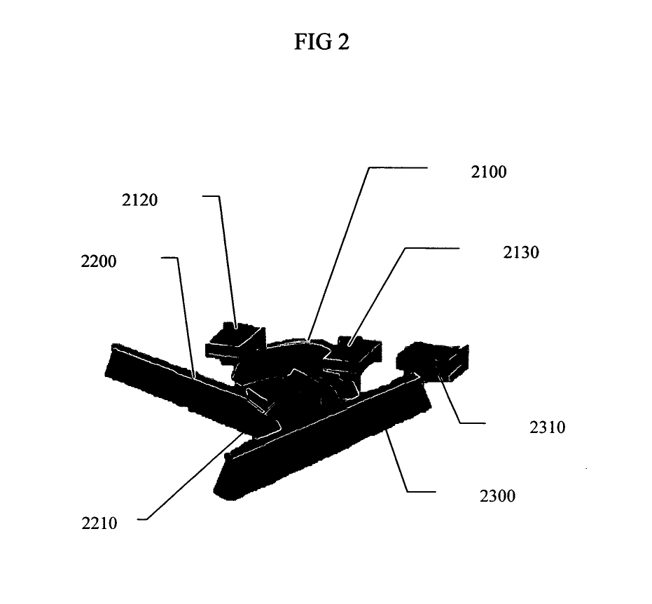

In the drawings each component or feature will be labeled with a four-digit label. The first digit corresponds to the drawing or figure number. For example, all components or features in FIG. 2 will be labeled as 2xxx, where xxx is the label of the component or feature appearing in FIG. 2. The following labels are assigned to components or features:

000 the exemplary embodiment of the sweeping apparatus

100 the center broom having fork receivers

110 the brush of the center broom

120 right fork receiver of the center broom

130 left fork receiver of the center broom

200 right broom having a fork receiver with a broom angle adjusting mechanism

220 brush of the right broom

210 fork receiver of the right broom

300 left broom having a fork receiver with a broom angle adjusting mechanism

310 fork receiver of the left broom

320 left broom brush

312 left broom pivot for adjusting the angle of the left broom

314 bolt for tightening left broom angle adjustment

### DETAILED DESCRIPTION

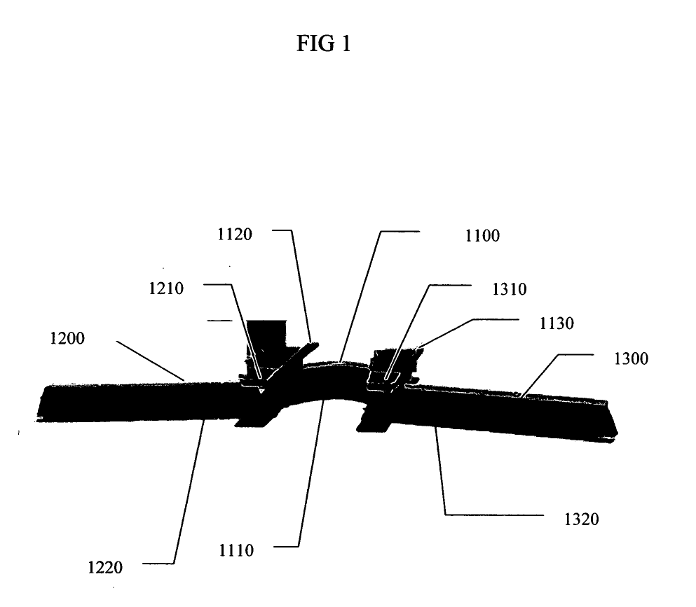

With reference to the accompanying figures an exemplary embodiment of a sweeping apparatus for mounting to and use with a forklift. The sweeping apparatus is mounted to the forks of a forklift and used to sweep and area by driving the forklift. FIG. 1 shows the exemplary embodiment, as mounted onto a standard forklift.

With reference to FIG. 1, the sweeper 1000 comprises: (1) a center broom 1100, the center broom 1100 having a brush 1110, the brush 1110 mounted and held by a right fork receiver 1120, and a left fork receiver 1130. FIG. 1 shows a preferred configuration of the center broom 1100 having a concave shape, whereby the center broom 1100 traps and holds debris directed and swept into the center of the sweeper 1000. With reference to FIG. 1, the sweeper further comprises a right broom 1200 and a left broom 1300. The right broom 1200 comprises a brush 1220 and a right fork receiver 1210. The right brush 1220 is rotatably attached to the right fork receiver 1210, so that the angle of the right brush 1220 can be changed to meet constraints imposed by the environment swept. The right fork receiver is configured to receive and be held by the right fork of the forklift onto which the sweeper 1000 is mounted. The sweeping apparatus 1000 further comprises a left broom 1300; the left broom 1300 also has a left brush 1320 and a left fork receiver 1310. The left brush 1320 also may be adjusted to different angles as required by the environment cleaned.

FIG. 2 shows the sweeper components. The right fork receiver 2210 and the left fork receiver 2310 are made in the shape of channels or sleeves that fit over the forks of a forklift. The size of the channel or opening within the receivers 2210 and 2310 are such that the receivers 2210 and 2310 will fit tightly over and around the forklift forks, but may be removed quickly and easily. Similarly, the left receiver 2120 and the left receiver 2130 of the center broom 2100 are made to be received by the forks of the forklift, to be held tightly and yet, to be removed quickly.

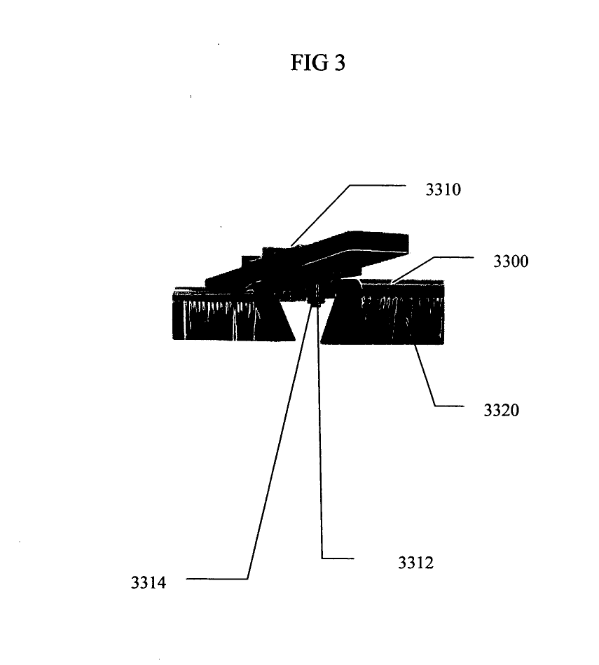

FIG. 3 shows the left broom 3300 of the sweeper. The bottom of the left fork receiver 3310 has a pivot mechanism 3312, that receives the left brush 3320, wherein the left brush 3320 may rotated and held fixed by screwing and un-screwing a bolt 3314 that locks and unlocks the pivot mechanism.

### Variations of the Exemplary Embodiment

The exemplary embodiment may be varied in the following manner:

1. Rather than three separate brooms, the sweeper may be made using a single brush mounted into a left fork receiver and a right fork receiver.

2. The center broom may be made in a “V” shape rather than a rounded concave shape, as shown.

3. The brushes may be held fixed in the left and right receivers, rather than using an adjustment means.

### DISCLOSURE SUMMARY

A single exemplary embodiment and a variant of the embodiment of the invention have been disclosed. It will be appreciated that the embodiment and its variant are directed to a sweeping apparatus that may be attached to and used with a forklift. The sweeper is seen to be simple and easy to use.

The full scope and description of the invention is given by the claims that follow.

1. (canceled)

2. A sweeping apparatus for attachment to the forks of a forklift, the apparatus comprising:
a center broom having a concave brush, the concave brush for sweeping, receiving and retaining debris swept by the apparatus, the center broom having a right and left receiver configured to be held by the forklift forks;
a left broom having a brush, the left broom having a left broom receiver configured to be held by the left forklift fork, the left broom brush sweeping and diverting debris to the center broom concave brush, and;
a right broom having a brush, the right broom having a right broom receiver configured to be held by the right forklift fork, the right broom brush sweeping and diverting debris to the center broom concave brush.

3. The sweeping apparatus of claim 2, wherein the left broom may be selectively rotated with respect to the left forklift fork.

4. The sweeping apparatus of claim 2, wherein the right broom may be selectively rotated with respect to the right forklift fork.

5. A sweeping apparatus for attachment to the forks of a forklift, the apparatus comprising:
a center broom having a concave brush, the concave brush for sweeping, receiving and retaining debris swept by the apparatus, the center broom having a right and left receiver adapted to receive and be held by the forklift forks as the apparatus sweeps;
a left broom having a brush, the left broom having a left broom receiver adapted to receive and to be held by the left forklift fork, the left broom selectively and independently rotated with respect to the left forklift fork to sweep and divert debris to the center broom concave brush, and;
a right broom having a brush, the right broom having a right broom receiver adapted to receive and to be held by the right forklift fork, the right broom selectively and independently rotated with respect to the right forklift fork to sweep and divert debris to the center broom concave brush.
